(19) United States
(12) Patent Application Publication
(10) Pub. No.: US 2009/0317021 A1
(43) Pub. Date: Dec. 24, 2009

(54) SHOPPING BAG SYSTEM

(76) Inventor: Jennifer Taylor, Burbank, CA (US)

Correspondence Address: ITALIA IP, 3500 WEST OLIVE AVE., SUITE 300, BURBANK, CA, 91505, US

(21) Appl. No.: 12/107,756

(22) Filed: Apr. 22, 2008

(51) Int. Cl. B65D 33/06; B65D 30/00; B60R 9/00

(52) U.S. Cl. 383/6; 383/37; 224/411

(57) ABSTRACT

A shopping bag system comprising a plurality of handled bags and a primary bag. The primary bag comprises a front face, a rear face, a pair of opposing end walls and a bottom. The end walls and bottom connect the front face to the rear face thereby defining a chamber. The chamber is capable of receiving the plurality of handled bags, and, upon removing the handled bags from the chamber, the chamber is capable of retaining shopping items therein. A fastener is coupled to one of the opposing end walls, the front face, or the rear face. The fastener is capable of releasably securing the primary bag to a shopping cart.

### BACKGROUND

This application relates generally to shopping bags. More specifically, this application relates to a shopping bag system which includes a primary bag and a plurality of handled bags.

### SUMMARY

The widespread use of shopping bags for carrying items purchased in various stores, and especially in markets where numerous items are packaged in bags for carrying the items home, more recently has come under close scrutiny from the standpoint of conservation and preservation of the ecology. Thus, use of the ubiquitous disposable paper bag has been questioned as being responsible for using up valuable resources to manufacture the bags as well as from the standpoint of overburdening the facilities for disposal of the bags. Plastic bags have been suggested as an alternative to paper bags, but even plastic bags use valuable resources and present disposal problems. Accordingly, it would be advantageous to have available a shopping bag system which is effective for marketing purposes and which does not tax resources and disposal facilities, yet is convenient and efficient so as to encourage use.

This application discloses a shopping bag system that is economical to produce, of simple construction and capable of mass production, but also capable of providing a user a suitable means to conveniently and efficiently store and transport shopping items.

In particular, this application discloses a shopping bag system comprising a plurality of handled bags and a primary bag. The primary bag comprises a front face, a rear face, a pair of opposing end walls and a bottom. The end walls and bottom connect the front face to the rear face thereby defining a chamber. The chamber is capable of receiving the plurality of handled bags, and, upon removing the handled bags from the chamber, the chamber is capable of retaining shopping items therein. A fastener is coupled to one of the opposing end walls, the front face, or the rear face. The fastener is capable of releasably securing the primary bag to a shopping cart.

This application also discloses a shopping bag system comprising a plurality of handled bags and a primary bag. The primary bag has an inner chamber capable of retaining the plurality of handled bags therein. In addition, upon removing the handled bags from the chamber, the chamber is operable to retain shopping items therein. A fastener is coupled to the primary bag and capable of releasably securing the primary bag to a shopping cart.

Finally, this application discloses a shopping bag system comprising a plurality of handled bags and a primary bag. The primary bag comprises a front face, a rear face, a pair of opposing corrugated end walls and a bottom. The end walls and bottom connect the front face to the rear face thereby defining a chamber. The chamber is capable of receiving the plurality of handled bags, and, upon removing the handled bags from the chamber, the chamber is capable of retaining shopping items therein. The primary bag is capable of a compact arrangement, where the front face is adjacent to the rear face, and an expanded arrangement, where the front face is space apart from the rear face. A fastener is coupled to one of the opposing end walls, the front face, or the rear face. The fastener is capable of releasably securing the primary bag to a shopping cart.

### BRIEF DESCRIPTION OF THE DRAWINGS

The drawings, when considered in connection with the following description, are presented for the purpose of facilitating an understanding of the subject matter sought to be protected.

FIG. 1 is an environmental view of a first embodiment of a shopping bag system showing the shopping bag system releasably secured to a shopping cart;

FIG. 2 is a perspective view of the shopping bag system of FIG. 1;

FIG. 3 is a top view of the shopping bag system of FIG. 1;

FIG. 4 is a perspective view of a handled bag;

FIG. 5 is a perspective view of a second embodiment of a shopping bag system showing the primary bag in a compact arrangement; and

FIG. 6 is a second perspective view of the shopping bag system of FIG. 4 showing the primary bag in an expanded arrangement.

### DETAILED DESCRIPTION

While the present shopping bag system is described with reference to several illustrative embodiments described herein, it should be clear that the present invention should not be limited to such embodiments. Therefore, the description of the embodiments provided herein is illustrative of the present invention and should not limit the scope of the invention as claimed.

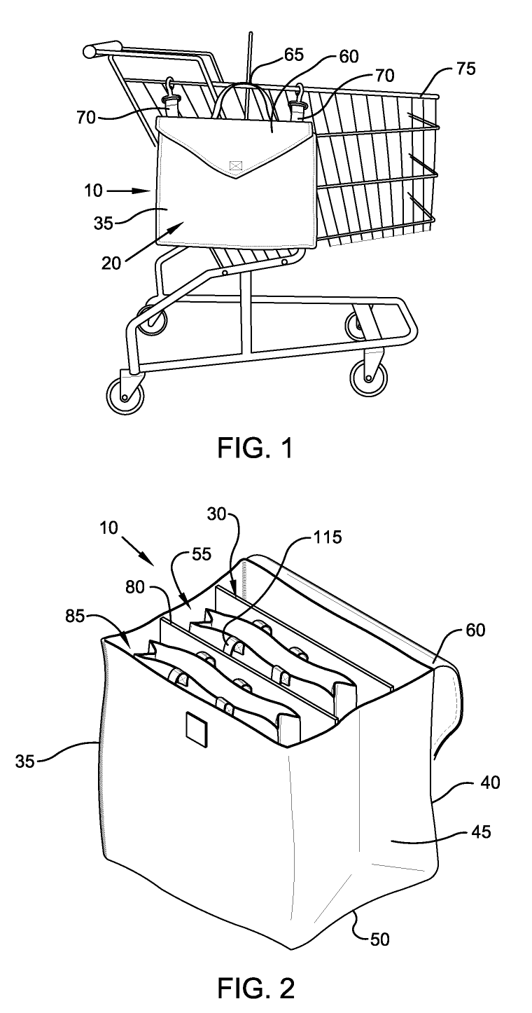

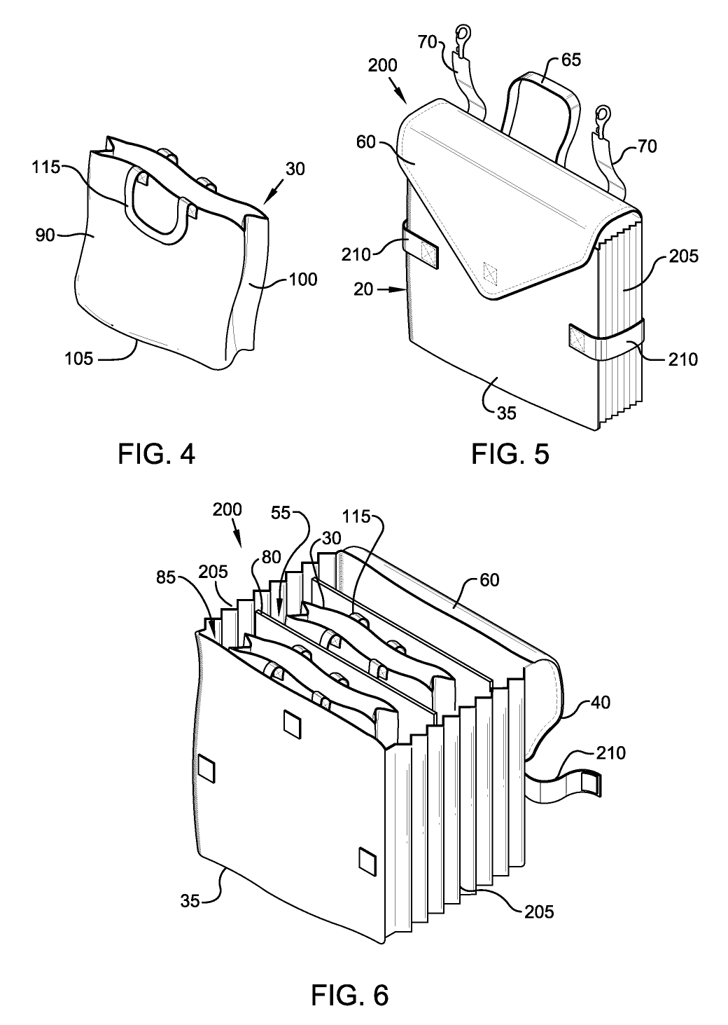

Referring now to FIGS. 1-4, a first illustrative embodiment of a shopping bag system 10 is shown. The shopping bag system 10 generally comprises a primary bag 20 and a plurality of handled bags 30. The primary bag 10 includes a front face 35, rear face 40, side walls 45 and a bottom 50. The primary bag 10 has an inner chamber 55 for receiving the plurality of handled bags 30 and/or shopping items. However, it will be appreciated that the primary bag 20 may have any suitable construction; for example, the primary bag may include front and rear panels which are secured together to form a pocket, or chamber, therebetween, etc. The primary bag 20 may be constructed from any suitable material, including but not limited to a polymer, fabric, etc. In addition, the primary bag 20 may be insulated to assist in maintaining the temperature of shopping items being transported therewith.

The primary bag 20 may include a top cover 60 which is hinged to the upper edge of the rear face 40. However, it will be appreciated that the top cover 60 may be hinged at any suitable location; for example, the top cover 60 may be hingedly secured to the front face 35, one of the side walls 45, etc. The top cover 60 may be releasably secured in a closed position to the front face 35 by any suitable means, including but not limited to Velcro, magnets, buckle, hooks, etc. Alternatively, the primary bag 20 may not have any top cover 60.

In addition, the primary bag 20 may also include a shoulder strap 65. While the illustrative embodiment shows the shoulder strap 65 affixed to the rear face 40, it will be appreciated that the shoulder strap 65 may be affixed at any suitable location; for example, the shoulder strap 65 may be affixed to at least one of the front face 35, side walls 45 and/or top cover 60.

The primary bag 20 also includes one or more swivel clips 70 secured to the rear face 40. However, it will be appreciated that the swivel clips 70 may be secured to any suitable location, such as the front face 35, side walls 45 and/or top cover 60. The swivel clips 70 are operable to releasably secure the primary bag 20 to a shopping cart 75. Thus, a user may releasably secure the primary bag 20 to a shopping cart 75 while the user shops. While the illustrative embodiment shows swivel clips 70 for securing the primary bag 20 to a shopping cart 75, it will be appreciated that any fastener suitable for releasably securing the primary bag 20 to a shopping cart 75 may be employed and are contemplated herein. Such fasteners may include, but are not limited to, magnets, Velcro straps, hooks, buckles, etc.

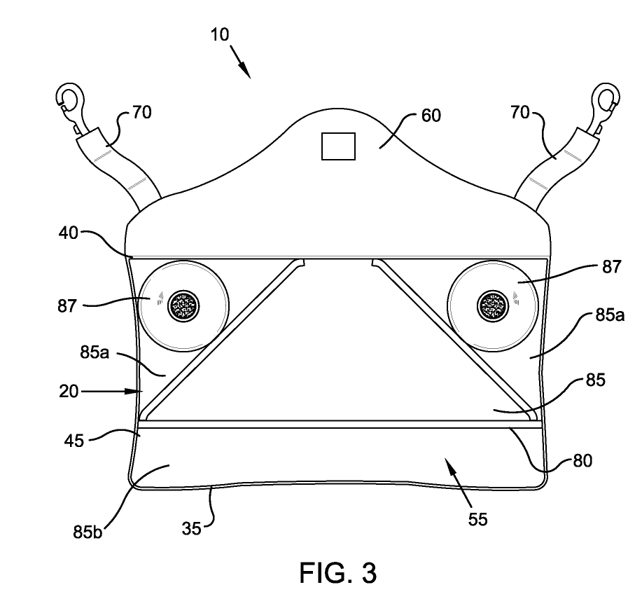

The primary bag 20 may also include one or more partitions 80 for subdividing the inner chamber 55 into smaller chambers 85 so as to assist in keeping the handled bags 30 organized and/or the shopping items organized or separated. The partitions 80 may be permanently affixed within the inner chamber 55 or may be releasably secured within the inner chamber 55 by any suitable means, including but not limited to Velcro, magnets, hooks, buckles, etc. For example, the front face 35, rear face 40, side walls 45 and/or top cover 60 may include loops operable to receive corresponding hooks on the one or more partitions 80 such that the user may subdivide the inner chamber 55 into any suitable number and/or any suitably shaped smaller chambers 85, 85a, 85b. As best shown in FIG. 3, a partition may be disposed from one side wall 45 to the rear face 40 so as to define a triangularly shaped smaller chamber 85a capable of receiving a bottle 87 therein. In addition, a partition 80 may be disposed between the side walls 45 to create a rectangularly shaped smaller chamber 85b. The number of inner chambers 85, 85a, 85b, and shapes thereof may be selected by the user to best fit his or her needs. Thus, the forgoing shapes and numbers of chambers 85, 85a, 85b are by way of example only and the various ways to arrange the partitions 80 to create the desired number and/or shape of the inner chambers 85, 85a, 85b will be readily apparent to one skilled in the art. Additionally, the partitions 80 may be padded to protect shopping items and/or insulated to assist in maintaining the temperature of shopping items being transported therewith. Moreover, the primary bag 20 may also include other items such as ice packs, gels packs, padding, wine bag(s), etc.

The handled bags 30 are generally known in the art. Typically, the handled bags generally include a front face 90, rear face 95, a pair of side walls 100, and a base 105, which define a compartment 110 for receiving shopping items. However, the handled bags 30 may have any suitable construction as is known in the art, and every such construction is contemplated herein. The handled bags 30 may also include one or more handles 115 that may be affixed to the bag 30 or may be integral with the bag 30. The handled bags 30 may be constructed from any suitable material, including but not limited to a polymer, fabric, etc. Also, at least some of handled bags 30 may be insulated to assist in maintaining the temperature of shopping items being transported therewith. Furthermore, the handled bags 30 may be of the same size or may be different sizes.

In use, the handled bags 30 are retained within the inner chamber 55 of the primary bag 20. The user may then transport the shopping bag system 10 to a shopping location. The primary bag 20 may then be affixed to a shopping cart 75 through the use of the swivel clips 70. Once the user is finished shopping, the user may begin to remove the handled bags 30 from the primary bag 20 and use them to store shopping items therein. In addition, the user may also use the primary bag 20 to store shopping items therein. Once the user is finished with the bags 20, 30, the handled bags 30 may be returned to the primary bag 20.

Referring now to FIGS. 5-6, a second illustrative embodiment of a shopping bag system 200 is shown. The system 200 is similar to that of the first embodiment described above; thus, like numerals for like elements will be used throughout. The primary difference between the first illustrative embodiment and the second illustrative embodiment resides within side walls 205. In the second embodiment, the side walls 205 are corrugated thereby allowing the primary bag 20 to operate in an accordion-like fashion. Thus, the primary bag 20 may be moveable from a compact arrangement where the front face 35 is adjacent to the rear face 40 and an expanded arrangement where the front face 35 is spaced apart from the rear face 40. In addition, the primary bag may include a strap 210 coupled to the rear face 40. The strap 210 extends to, and is releasably securable to, the front face 35 such that when the strap 210 is secured to the front face 35, the primary bag 20 is retained in the compact arrangement, and when the strap 210 is released from the front face 35, the primary bag 20 may be moved to the expanded arrangement. The strap 210 may be releasably secured to the front face 35 by any suitable means, including but not limited to Velcro, magnets, buckle, hooks, etc.

In use, the handled bags 30 are retained within the inner chamber 55 of the primary bag 20. The user may then press the front face 35 towards the rear face 40 such that the primary bag 20 is in the compact arrangement. The strap 210 may be releasably secured to the front face 35 so as to retain the primary bag 20 in the compact arrangement. The user may then transport the shopping bag system 200 to a shopping location. The primary bag 20 may then be affixed to a shopping cart 75 through the use of the swivel clips 70. Once the user is finished shopping, the user may release the strap 210 from the front face 35 of the primary bag 20 thereby allowing the primary bag 20 to move to the expanded arrangement. Next, the user may begin to remove the handled bags 30 from the primary bag 20 and use them to store shopping items therein. In addition, the user may also use the primary bag 20 to store shopping items therein. Once the user is finished with the bags 20, 30, the handled bags 30 may be returned to the primary bag 20.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A bag system comprising:
a plurality of handled bags;
a primary bag comprising a front face, a rear face, a pair of opposing end walls and a bottom, wherein said opposing end walls and said bottom connect said front face to said rear face thereby defining a chamber capable of receiving said plurality of handled bags and wherein upon removing said handled bags from said chamber, said chamber is operable to retain shopping items therein; and
a fastener coupled to one of said opposing end walls, said front face, or said rear face, said fastener capable of releasably securing said primary bag to a shopping cart.

2. The bag system of claim 1 further comprising a partition, said partition capable of being releasably secured within said chamber to subdivide said chamber.

3. The bag system of claim 2 wherein said partition is insulated.

4. The bag system of claim 1 wherein said primary bag is insulated.

5. The bag system of claim 1 wherein said fastener is a swivel clip.

6. The bag system of claim 1 wherein said fastener is a magnet.

7. The bag system of claim 1 wherein said fastener is a Velcro strap.

8. A bag system comprising:
a plurality of handled bags;
a primary bag having an inner chamber, said chamber capable of retaining said plurality of handled bags therein, wherein upon removing said handled bags from said chamber, said chamber is operable to retain shopping items therein; and
a fastener coupled to said primary bag, said fastener capable of releasably securing said primary bag to a shopping cart.

9. The bag system of claim 8 wherein said primary bag is insulated.

10. The bag system of claim 8 further comprising a partition, said partition capable of being releasably secured within said chamber to subdivide said chamber.

11. The bag system of claim 10 wherein said partition is insulated.

12. The bag system of claim 8 wherein said fastener is a swivel clip.

13. The bag system of claim 8 wherein said fastener is a magnet.

14. The bag system of claim 8 wherein said fastener is a Velcro strap.

15. A bag system comprising:
a plurality of handled bags;
a primary bag comprising a front face, a rear face, a pair of opposing end walls, each of said end walls being corrugated and a bottom, wherein said opposing end walls and said bottom connect said front face to said rear face thereby defining a chamber capable of receiving said plurality of handled bags, wherein upon removing said handled bags from said chamber, said chamber is operable to retain shopping items therein, and wherein said primary bag is capable of a compact arrangement wherein said front face is adjacent to said rear face and a expanded arrangement wherein said front face is spaced apart from said rear face; and
a fastener coupled to one of said opposing end walls, said front face, or said rear face, said fastener capable of releasably securing said primary bag to a shopping cart.

16. The bag system of claim 15 further comprising a partition, said partition capable of being releasably secured within said chamber to subdivide said chamber.

17. The bag system of claim 15 wherein said primary bag is insulated.

18. The bag system of claim 15 further comprising a strap coupled to said rear face, said strap capable of releasably engaging said front face to retain said primary bag in said compact arrangement.

19. The bag system of claim 15 wherein said fastener is a swivel clip.

20. The bag system of claim 15 wherein said fastener is a magnet.
